(19) United States
(12) Patent Application Publication
(10) Pub. No.: US 2016/0068362 A1
(43) Pub. Date: Mar. 10, 2016

(54) LABEL SHEET CUTTING APPARATUS

(71) Applicant: Graphtec Corporation, a corporation duly organized and existing under the laws of Japan, Kanagawa (JP)

(72) Inventors: Yuichi Oyane, Kagawa (JP); Yuzuru Sekiguchi, Kanagawa (JP)

(21) Appl. No.: 14/843,311

(22) Filed: Sep. 2, 2015

(30) Foreign Application Priority Data
Sep. 5, 2014 (JP) 2014-180926

(51) Int. Cl. B65H 35/00; B26D 7/26; B26D 1/24

(52) U.S. Cl. CPC B65H 35/008; B26D 1/245; B26D 7/2621

(57) ABSTRACT

A label sheet cutting apparatus includes a first rotating shaft and a second rotating shaft arranged parallel to each other, a driving device configured to rotate the first rotating shaft and the second rotating shaft, and a cutter unit including a first disc-like rotary blade and a second disc-like rotary blade each having a hole in a center, and a holding member configured to rotatably support the first rotary blade and the second rotary blade, and hold one surface of the first rotary blade and one surface of the second rotary blade such that the two surfaces are partially in contact with each other, the cutter unit configured to cut a sheet-like medium to be cut which is fed to pass between the first rotary blade and the second rotary blade. The first rotating shaft and the second rotating shaft are inserted into the holes of the first rotary blade and the second rotary blade and rotate the first rotary blade and the second rotary blade, respectively, and support the cutter unit such that the cutter unit is movable in an axial direction of the first rotating shaft and the second rotating shaft.

### PRIORITY CLAIM

This application claims priority to Japanese Application Serial No. 2014-180926 filed Sep. 5, 2014.

### BACKGROUND OF THE INVENTION

1. Field of the Invention

The present invention relates to a cutting apparatus for cutting, in the widthwise direction, a sheet-like medium to be cut, particularly a label sheet including a release sheet and a label laminated to be releasable on this release sheet.

2. Description of the Relevant Art

Examples of a conventional cutting apparatus for obtaining a plurality of band-like materials from a sheet-like medium to be cut such as paper or a plastic film are described in Japanese Patent Laid-Open No. 2001-38674 (literature 1) and Japanese Patent Laid-Open No. 11-58558 (literature 2).

The cutting apparatus disclosed in literature 1 includes a cylindrical support member for holding a sheet-like medium to be cut by winding it, and a plurality of rotary blades attached to a rotating shaft parallel to this cylindrical support member.

The cylindrical support member has a plurality of annular grooves into which the edges of the rotary blades are inserted.

The plurality of rotary blades are formed into a circular shape when viewed in the axial direction, and attached to one rotating shaft via an attaching structure capable of changing the attaching positions in the axial direction.

In this cutting apparatus, the medium to be cut is wound on the cylindrical support member and cut as the rotary blades are inserted into the annular grooves while rotating together with the rotating shaft.

The cutting apparatus described in literature 2 includes a first rotary blade positioned on the obverse surface side of a sheet-like medium to be cut, and a second rotary blade positioned on the reverse surface side of the medium to be cut. The first and second rotary blades are respectively formed into a circular shape when viewed in the axial direction, and respectively attached to rotating shafts in contact with each other in the axial direction. The first rotary blade can move in the axial direction with respect to the second rotary blade. The second rotary blade cannot move in the axial direction.

In this cutting apparatus disclosed in literature 2, the medium to be cut is fed toward the first and second rotary blades, and cut as it is clamped between the first and second rotary blades in rotation, thereby being divided in the widthwise direction.

The cutting apparatus disclosed in literature 1 has the problem that the cut section of the band-like material obtained by cutting the medium to be cut is not smooth but rough. The reason why the quality of the cutting process is low is probably because a part of the medium to be cut pushed by the rotary blade during cutting moves as it is pushed into the annular groove of the cylindrical support member.

This inconvenience can be eliminated by using the cutting apparatus described in literature 2. In the cutting apparatus disclosed in literature 2, a band-like material having a smooth cut section can be obtained because the medium to be cut is cut without moving as it is clamped between the two rotary blades.

In the cutting apparatus disclosed in literature 2, however, the first and second rotary blades cannot be moved in the axial direction in a state in which these rotary blades are in contact with each other in the axial direction. Accordingly, this cutting apparatus has the problem that the width of a band-like material cannot be changed in accordance with the application.

### SUMMARY OF THE INVENTION

The present invention has been made to solve the problems as described above, and has as its object to provide a cutting apparatus capable of readily changing, in accordance with the application, the width of a band-like material obtained by cutting a sheet-like medium to be cut, and capable of improving the quality of the cutting process by using two rotary blades which clamp the medium to be cut.

To achieve the above object, a label sheet cutting apparatus according to the present invention includes a first rotating shaft and a second rotating shaft arranged parallel to each other, a driving device configured to rotate the first rotating shaft and the second rotating shaft, and a cutter unit including a first disc-like rotary blade and a second disc-like rotary blade each having a hole in a center, and a holding member configured to rotatably support the first rotary blade and the second rotary blade, and hold one surface of the first rotary blade and one surface of the second rotary blade such that the two surfaces are partially in contact with each other, the cutter unit configured to cut a sheet-like medium to be cut which is fed to pass between the first rotary blade and the second rotary blade, wherein the first rotating shaft and the second rotating shaft are inserted into the holes of the first rotary blade and the second rotary blade and rotate the first rotary blade and the second rotary blade, respectively, and support the cutter unit such that the cutter unit is movable in an axial direction of the first rotating shaft and the second rotating shaft.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 is a perspective view of a digital finishing cutter including a label sheet cutting apparatus according to an embodiment of the present invention;

FIG. 2 is a front view showing a cutting section of the label sheet cutting apparatus;

FIG. 3 is a perspective view showing the front side of the cutting section of the label sheet cutting apparatus seen obliquely from above;

FIG. 4 is a rear view showing a cutting unit;

FIG. 5 is a left side view of the cutting unit;

FIG. 6 is a right side view of the cutting unit;

FIG. 7 is a perspective view showing the front side of the cutting unit seen obliquely from above;

FIG. 8 is a perspective view showing the rear side of the cutting unit seen obliquely from above;

FIG. 9 is a block diagram showing the arrangement of a controller of the label sheet cutting apparatus;

FIG. 10 is a side view showing the arrangement of an orbit guide and winding device;

FIG. 11A is a schematic view for explaining the contact angle between a medium to be cut and rotary blade;

FIG. 11B is a schematic view for explaining the contact angle between the medium to be cut and rotary blade;

FIG. 12 is a plan view showing a part of a label sheet; and

FIG. 13 is a sectional view showing the part of the label sheet.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

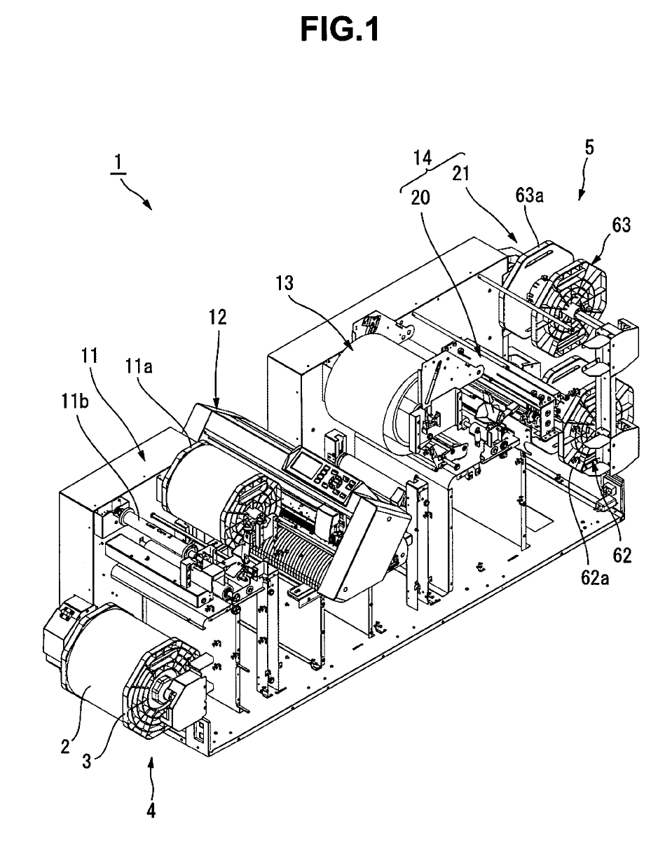

An embodiment of a label sheet cutting apparatus (to be simply referred to as “a cutting apparatus” in some cases hereinafter) according to the present invention will be explained in detail below with reference to FIGS. 1 to 13. In this embodiment, an example of a case in which the present invention is applied to a cutting apparatus of a digital finishing cutter will be explained.

A digital finishing cutter 1 shown in FIG. 1 divides a sheet-like medium 2 to be cut made of a web material in the widthwise direction by cutting it, and winds into two rolls. The medium 2 to be cut is a label sheet formed by laminating an adhesive sheet on a release sheet. The medium 2 to be cut is mounted in the digital finishing cutter 1 in the form of a roll wound on an unwinder 3.

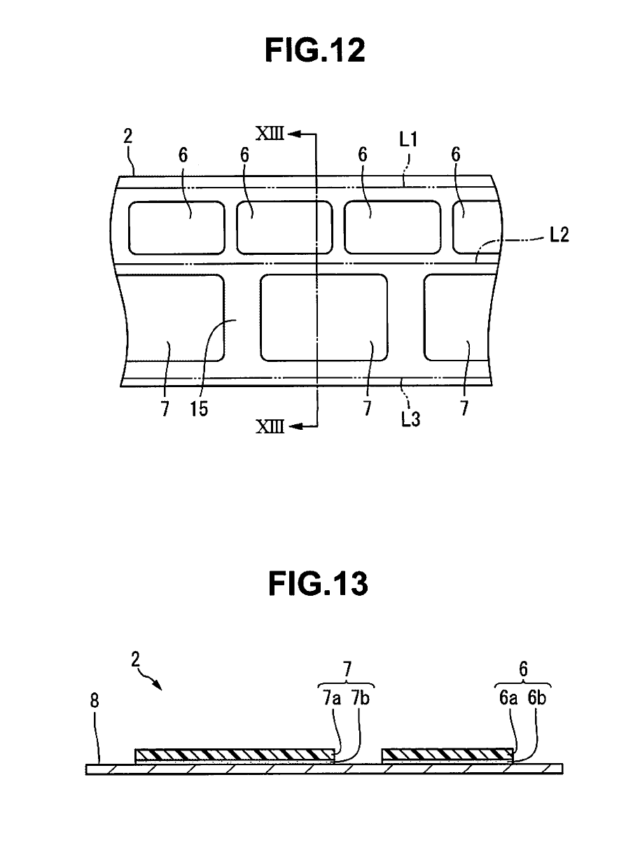

The digital finishing cutter 1 feeds the medium 2 to be cut from a supply unit 4 positioned in the lower left portion of FIG. 1 to a discharge unit 5 positioned in the upper right portion of FIG. 1. On the label sheet 2, the contours of first labels 6 and second labels 7 to be cut into adhesive labels by a cutting plotter 12 as will be described later may also be printed beforehand so that the first and second labels 6 and 7 are arranged in the widthwise direction (the vertical direction in FIG. 12) and the longitudinal direction. Referring to FIG. 12, the width of the first label 6 is larger than that of the second label 7.

A plurality of processing apparatuses are arranged along the conveying path of the medium 2 to be cut in the digital finishing cutter 1. As shown in FIG. 1, these processing apparatuses are a laminate processing apparatus 11, the cutting plotter 12, a refuse removal apparatus 13, and a cutting apparatus 14. The laminate processing apparatus 11 includes a laminate film supply winder 11a, a mount winding roller 11b, and a press roller (not shown) for pressing a laminate film against the medium 2 to be cut, and performs a laminating process on the medium 2 to be cut. The cutting plotter 12 cuts the medium 2 to be cut along the contours of the first and second labels 6 and 7.

The refuse removal apparatus 13 removes an unnecessary portion 15 (see FIG. 12) of the adhesive sheet of the label sheet 2 as a medium to be cut, except for the first and second labels 6 and 7.

FIG. 13 shows the section of the label sheet 2 from which the unnecessary portion 15 of the adhesive sheet is removed. The label sheet 2 includes a release sheet 8, and the first and second labels 6 and 7 laminated to be releasable on the release sheet 8. The labels 6 and 7 respectively include sheet-like substrates 6a and 7a and adhesive layers 6b and 7b.

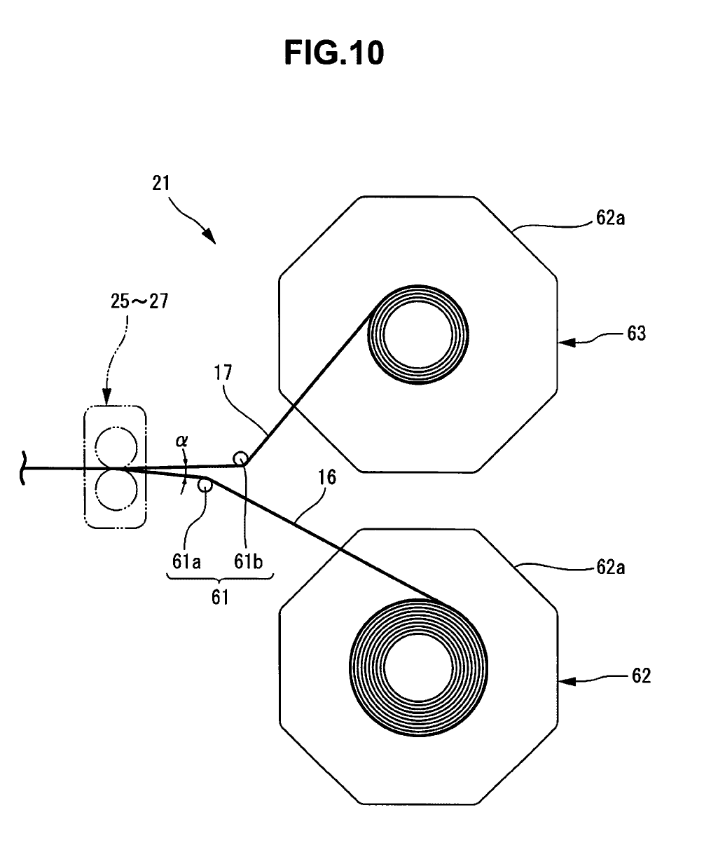

As will be described in detail later, the cutting apparatus 14 includes a cutting unit 20 for forming two band-like materials 16 and 17 (see FIG. 10) by dividing the medium 2 to be cut in the widthwise direction, and a winding unit 21 for winding the band-like materials 16 and 17. To divide the label sheet 2 into the plurality of band-like materials 16 and 17, a portion from which the adhesive sheet is removed is cut. That is, the cutting apparatus 14 cuts the release sheet 8 of the label sheet 2 as a medium to be cut, in order to avoid the adhesive of the adhesive layer from sticking to the blade of the cutter.

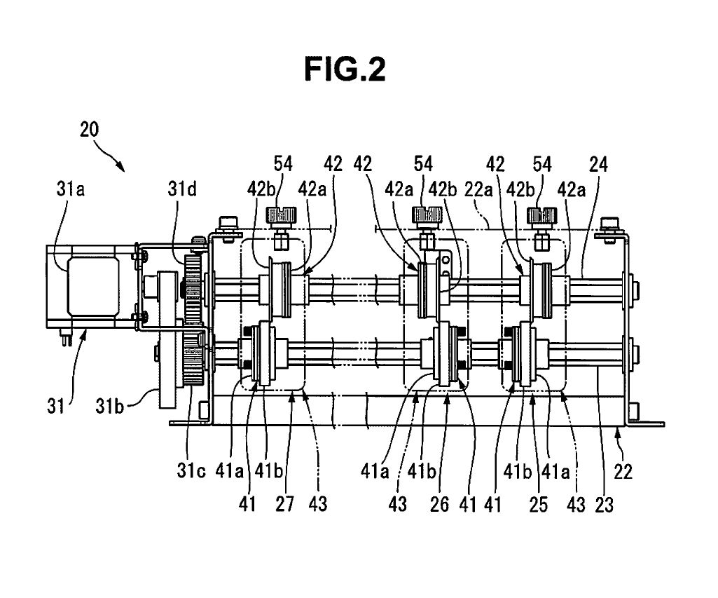

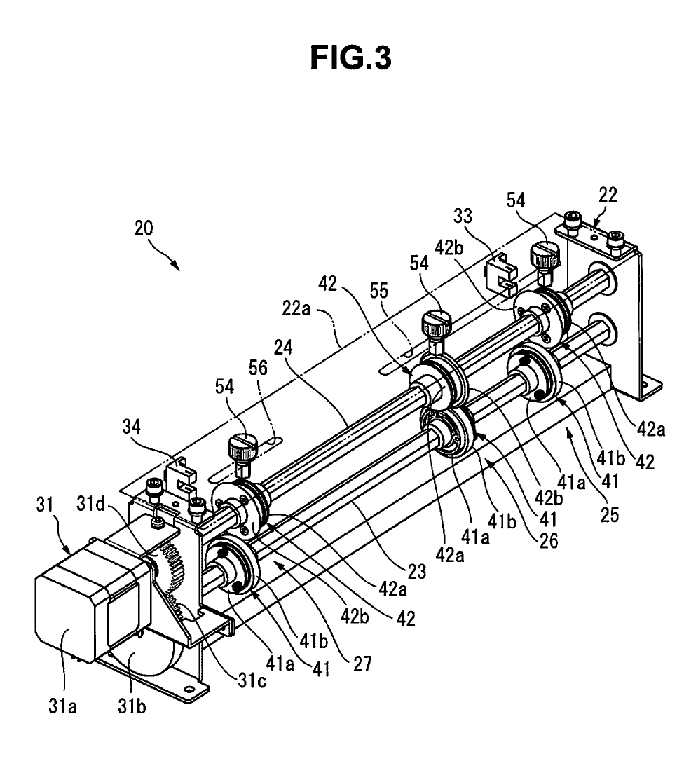

As shown in FIGS. 2 and 3, the cutting unit 20 of the cutting apparatus 14 includes a frame 22 having a shape covering the outside, two rotating shafts 23 and 24 formed in the frame 22, first to third cutter units 25 to 27 arranged in three portions in the axial direction of the rotating shafts 23 and 24, and a driving device 31 for rotating the rotating shafts 23 and 24.

The two end portions of each of the two rotating shafts 23 and 24 are rotatably supported by the frame 22. The rotating shafts 23 and 24 are spaced apart from each other by a predetermined interval in the vertical direction, and arranged parallel to each other. The axial direction of the two rotating shafts 23 and 24 is parallel to the medium 2 to be cut, and perpendicular to the feeding direction of the medium 2 to be cut. Note that “the axial direction” to be used when explaining the arrangement of each member hereinafter is the axial direction of the rotating shafts 23 and 24.

The medium 2 to be cut is passed between the two rotating shafts 23 and 24. In the following description, a lower one of the two rotating shafts 23 and 24 will be referred to as a first rotating shaft 23, and the other rotating shaft will be referred to as a second rotating shaft 24.

The first rotating shaft 23 extends along the lower surface of the medium 2 to be cut. The second rotating shaft 24 is arranged parallel to the first rotating shaft 23, in a position where the second rotating shaft 24 faces the first rotating shaft 23 with the medium 2 to be cut being sandwiched between them. In this embodiment, the shape of a section perpendicular to the axis of each of the first and second rotating shafts 23 and 24 is a regular hexagon.

The driving device 31 for rotating the first and second rotating shafts 23 and 24 is connected to one end portion (the left end portion in FIG. 2) of the first rotating shaft 23 and one end portion of the second rotating shaft 24. The driving device 31 reduces the speed of the rotation of a motor 31a by a belt-type reducer 31b, and transmits the rotation to the first rotating shaft 23. The rotation of the first rotating shaft 23 is transmitted to the second rotating shaft 24 via gears 31c and 31d. The driving device 31 rotates the first and second rotating shafts 23 and 24 in an operation state in which the medium 2 to be cut is fed to the cutting apparatus 14. Also, the driving device 31 stops when a controller 32 shown in FIG. 9 turns off the power supply, or when first and second sensors 33 and 34 (see FIG. 3) (to be described later) shift from a non-sensing state to a sensing state.

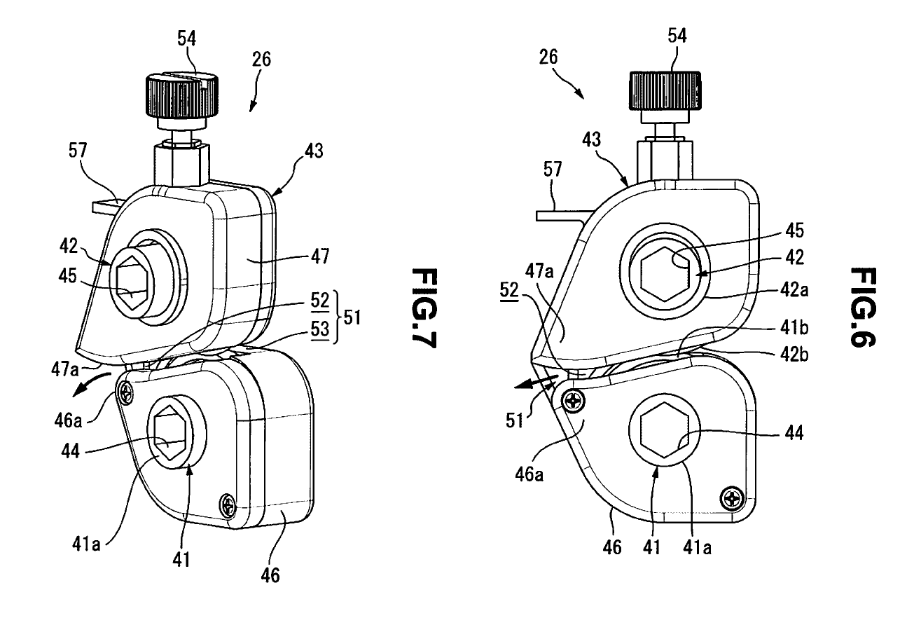

As shown in FIGS. 2 and 3, the first to third cutter units 25 to 27 each include first and second disc-like rotary blades 41 and 42, and a housing 43 covering the first and second rotary blades 41 and 42. The first rotary blade 41 includes a rotary member 41a having a hole 44 (see FIG. 7) in the center, and a blade body 41b (see FIG. 2) attached to the rotary member 41a. The blade body 41b is formed into a circular shape when viewed in the axial direction of the first rotating shaft 23, and attached to the rotary member 41a so as to rotate together. The blade body 41b is positioned on the same axis as that of the first rotating shaft 23.

The second rotary blade 42 includes a rotary member 42a having a hole 45 (see FIG. 7) in the center, and a blade body 42b (see FIG. 2) attached to the rotary member 42a. The blade body 42b is formed into a circular shape when viewed in the axial direction of the second rotating shaft 24, and attached to the rotary member 42a so as to rotate together. The blade body 42b is positioned on the same axis as that of the second rotating shaft 24.

The shape of the hole 44 of the first rotary blade 41 is a regular hexagon in which the first rotating shaft 23 fits to be movable in the axial direction. The shape of the hole 45 of the second rotary blade 42 is a regular hexagon in which the second rotating shaft 24 fits to be movable in the axial direction. The first and second rotating shafts 23 and 24 are respectively inserted into the holes 44 and 45 of the first and second rotary blades 41 and 42. That is, the first and second rotating shafts 23 and 24 rotate the first and second rotary blades 41 and 42, and support the first to third cutter units 25 to 27 so that they are movable in the axial direction.

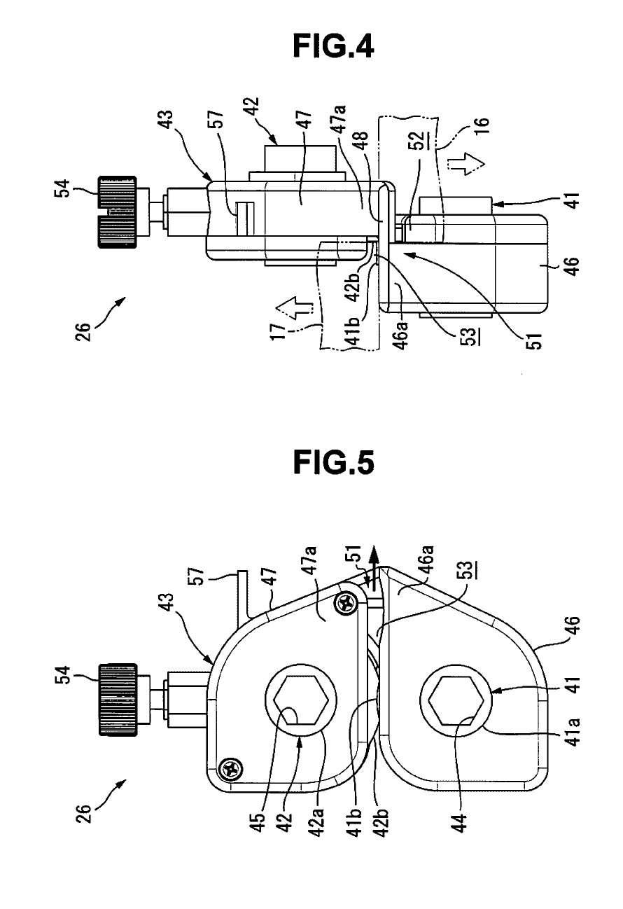

As shown in FIGS. 4 to 8, the housing 43 according to this embodiment includes a lower housing 46 covering the first rotary blade 41, an upper housing 47 covering the second rotary blade 42, and a connecting member 48 connecting the lower housing 46 and upper housing 47. As shown in FIG. 7, the lower housing 46 is formed into a shape which partially exposes the upper end portion of the first rotary blade 41, and rotatably holds the rotary member 41a via a bearing (not shown).

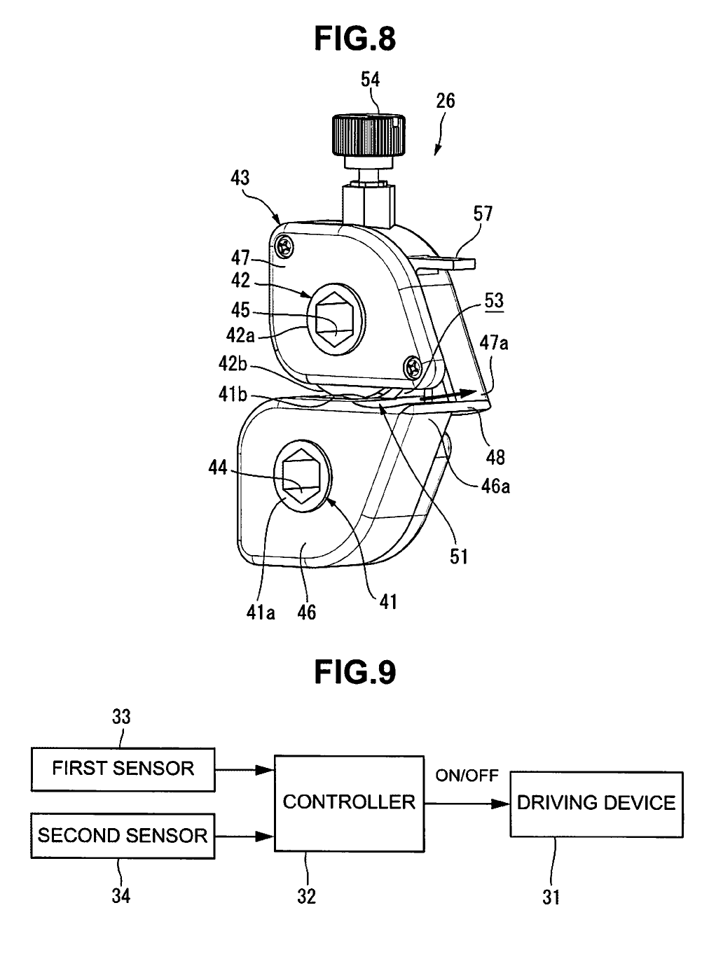

As shown in FIG. 8, the upper housing 47 is formed into a shape which partially exposes the lower end portion of the second rotary blade 42, and rotatably holds the rotary member 42a via a bearing (not shown). The lower housing 46 and upper housing 47 are connected by the connecting member 48 (to be described later), and hence are positioned in a place which implements a predetermined assembled state of the first and second rotary blades 41 and 42. As shown in FIG. 2, this “predetermined assembled state” is a state in which one surface of the first rotary blade 41 and one surface of the second rotary blade 42 are partially in contact with each other in the axial direction while rotating, and the medium 2 to be cut is fed between the blade bodies 41b and 42b and cut while passing between them. That is, as “a holding member”, the housing 43 rotatably supports the first and second rotary blades 41 and 42, and holds one surface of the rotary blade 41 and one surface of the rotary blade 42 such that these surfaces are partially in contact with each other.

As shown in FIG. 8, the connecting member 48 connects the lower housing 46 and upper housing 47 on the downstream side of the first to third cutter units 25 to 27. More specifically, the connecting member 48 is positioned downstream of the first and second rotary blades 41 and 42 in the feeding direction, and connects a read end portion 46a of the lower housing 46 and a rear end portion 47a of the upper housing 47 in a state in which an upper end portion of the lower housing 46, to which the first rotary blade 41 is partially exposed, and a lower end portion of the upper housing 47, to which the second rotary blade 42 is partially exposed, are spaced apart from each other and oppose each other.

As shown in FIGS. 5 to 8, in the housing 43 according to this embodiment, a branch guide 51 is formed between the upper end portion of the lower housing 46 and the lower end portion of the upper housing 47, and on two sides sandwiching the first and second rotary blades 41 and 42 in contact with each other. The branch guide 51 facilitates separating two band-like materials (the band-like materials 16 and 17 in FIG. 4) made of the medium 2 to be cut which is cut by the first and second rotary blades 41 and 42, in the vertical direction on the downstream side of the feeding direction and before the connecting member 48.

As described above, the connecting member 48 is positioned downstream of the first and second rotary blades 41 and 42 in the feeding direction, and the branch guide 51 separates the orbits of two band-like materials (the band-like materials 16 and 17 in FIG. 4) in the vertical direction before the connecting member 48. Consequently, the band-like materials are fed downstream with their orbits being not disturbed by the connecting member 48.

The branch guide 51 includes a lower passage 52 through which one of the two above-described, band-like materials (the band-like material 16 in FIG. 4) positioned below the blade body 42b of the second rotary blade 42 passes, and an upper passage 53 through which the other band-like material (the band-like material 17 in FIG. 4) positioned above the blade body 41b of the first rotary blade 41 passes.

As shown in FIG. 4, the housing 43 is formed to be asymmetrical in the horizontal direction when viewed from the downstream side of the medium 2 to be cut in the feeding direction. As shown in FIGS. 5 and 6, therefore, the shapes of the lower passage 52 and upper passage 53 described above are different when viewed sideways. FIG. 5 is a left side view showing the left side of the housing 43 when viewed from the downstream side. FIG. 6 is a right side view showing the right side of the housing 43 when viewed from the downstream side.

The opposing surfaces of the lower housing 46 and upper housing 47 shown in FIG. 5 are formed to be almost horizontal so that the medium 2 to be cut moves while drawing an almost horizontal orbit. Therefore, the downstream-side end portion of the upper passage 53 shown in FIG. 5 is formed to be almost horizontal so that the cut band-like material draws an almost horizontal orbit. As shown in FIGS. 4 and 8, the upper passage 53 communicates with the upper side of the connecting member 48. Accordingly, the band-like material passing through the upper passage 53 is almost horizontally guided to the downstream side over the connecting member 48.

On the other hand, the opposing surfaces of the lower housing 46 and upper housing 47 shown in FIG. 6 are formed into a shape by which the medium 2 to be cut moves while drawing a downward orbit. That is, the downstream-side end portion of the lower passage 52 shown in FIG. 6 is formed into a rounded shape so as to be gradually positioned below toward the downstream side. As shown in FIG. 7, the lower passage 52 communicates with the lower side of the connecting member 48. Therefore, the band-like material passing through the lower passage 52 is fed from the first to third cutter units 25 to 27 so as to draw a downward orbit.

That is, the branch guide 51 guides the pair of band-like materials obtained by cutting the medium 2 to be cut by the first and second rotary blades 41 and 42, in opposite directions at a predetermined angle in the vertical direction.

Of the first to third cutter units 25 to 27, the first cutter unit 25 and third cutter unit 27 positioned on the two sides are identical. The first and third cutter units 25 and 27 cut the two end portions in the widthwise direction of the medium 2 to be cut in positions indicated by alternate long and two short dashed lines L1 and L3 in FIG. 12.

As shown in FIG. 2, the second cutter unit 26 positioned in the center is formed to be axially symmetrical to each of the first and third cutter units 25 and 27 with respect to a virtual line extending in the vertical direction as the axis of symmetry, when viewed from the upstream side of the feeding direction of the medium 2 to be cut, and is attached to the first and second driving shafts 23 and 24. That is, the upper passage 53 formed in the first cutter unit 25 and the upper passage 53 formed in the second cutter unit 26 oppose each other. Also, the lower passage 52 formed in the third cutter unit 27 and the lower passage 52 formed in the second cutter unit 26 oppose each other.

As indicated by an alternate long and two short dashed line L2 in FIG. 12, the second cutter unit 26 cuts a portion between the first and second labels 6 and 7 arranged in the widthwise direction of the medium 2 to be cut. Therefore, one band-like material having the first labels 6 is fed from the cutting unit 20 to the winding unit 21 (to be described later) through one of the lower passage 52 and upper passage 53. Also, the other band-like material having the second labels 7 is fed to the winding unit 21 through the other passage.

The band-like material 16 passing through the lower passage 52 of the second cutter unit 26 is fed to the winding unit 21 through a portion below the connecting member 48. The band-like material 17 passing through the upper passage 53 of the second cutter unit 26 is fed to the winding unit 21 through a portion above the connecting member 48.

As a consequence, the two band-like materials 16 and 17 obtained by cutting the medium 2 to be cut by the first, second, and third cutter units 25, 26, and 27 can be discharged in opposite directions (in the vertical direction) perpendicular to the medium 2 to be cut.

The positions of the first to third cutter units 25 to 27 in the axial direction can be changed by moving the first to third cutter units 25 to 27 along the first and second rotating shafts 23 and 24. A shaft member 54 which a worker grips when moving the first to third cutter units 25 to 27 in the axial direction is formed on the upper end portion of the housing 43 according to this embodiment. The shaft member 54 is formed by a bolt.

The shaft member 54 is screwed, as “a shaft portion”, into the housing 43 through one of two slits 55 and 56 (see FIG. 3) formed in an upper wall 22a of the frame 22. The upper wall 22a as “a beam member” is formed parallel to the first and second rotating shafts 23 and 24. The first to third cutter units 25 to 27 are fixed to the upper wall 22a by screwing the shaft member 54 into the housing 43 and pushing the shaft member 54 against the upper wall 22a.

The two slits 55 and 56 regulate the moving ranges of the first to third cutter units 25 to 27. The two slits 55 and 56 extend in the axial direction, and are aligned in the axial direction. The slit 55 positioned on the right side in FIG. 3 is formed to be longer than the slit 56. In this embodiment, the shaft member 54 of the first cutter unit 25 and the shaft member 54 of the second cutter unit 26 are inserted into the longer slit 55. The shaft member 54 of the third cutter unit 27 is inserted into the shorter slit 56.

The lengths of the slits 55 and 56 are so set that the first to third cutter units 25 to 27 can move between a retraction position and use position. The retraction position is a position where the first and second rotary blades 41 and 42 of the first to third cutter units 25 to 27 extend outside the medium 2 to be cut when viewed from above. The use position is a position where the first and second rotary blades 41 and 42 can cut the medium 2 to be cut.

The first and second cutter units 25 and 26 can move within the moving range permitted by the longer slit 55. The third cutter unit 27 can move within the moving range permitted by the shorter slit 56.

The first sensor 33 (see FIG. 3) is arranged near the second cutter unit 26 having moved to the retraction position. Also, the second sensor 34 is arranged near the third cutter unit 27 having moved to the retraction position. Each of the first and second sensors 33 and 34 is formed by a photointerrupter and supported by the frame 22 via a bracket (not shown). Light-shielding plates 57 (see FIGS. 4 to 8) to be sensed by the sensors 33 and 34 are formed in the housing 43 of the second cutter unit 26 and the housing 43 of the third cutter unit 27.

The first sensor 33 is in a sensing state when the second cutter unit 26 is positioned in the retraction position. When the second cutter unit 26 is positioned in the retraction position, the first cutter unit 25 is also positioned in the retraction position. The second sensor 34 is in a sensing state when the third cutter unit 27 is positioned in the retraction position. That is, the first and second sensors 33 and 34 sense the presence/absence of the cutter units retracted to the two-end sides of the first and second rotating shafts 23 and 24.

The first and second sensors 33 and 34 are connected to the controller 32 (see FIG. 9) for controlling the operation of the digital finishing cutter 1, and send sensing signals to the controller 32 in the sensing state. The controller 32 is formed by a microprocessor or the like, and stops the driving device 31 when receiving both the sensing signals from the first and second sensors 33 and 34. That is, the controller 32 stops driving of the first and second rotating shafts 23 and 24 when the first and second sensors 33 and 34 sense the second and third cutter units 26 and 27 retracted to the two-end sides of the first and second rotating shafts 23 and 24.

As shown in FIG. 10, the winding unit 21 includes an orbit guide 61 arranged downstream of the first to third cutter units 25 to 27 and spaced apart by a predetermined distance from these cutter units, and a lower winding device 62 and upper winding device 63 positioned downstream of the orbit guide 61.

The orbit guide 61 regulates movement in a direction perpendicular to the surfaces of the two band-like materials 16 and 17 fed from the cutting unit 20 to the downstream side, and includes two rod-like rollers 61a and 61b arranged downstream of the first to third cutter units 25 to 27 and before the lower and upper winding devices 62 and 63.

The axial direction of the rotation of the rollers 61a and 61b is a horizontal direction perpendicular to the feeding direction of the medium 2 to be cut. Also, the rollers 61a and 61b are formed in positions spaced apart from each other in a direction perpendicular to the feeding direction of the medium 2 to be cut.

Of the two band-like materials 16 and 17 fed backward from the cutting unit 20, the band-like material 16 having passed below the connecting member 48 of the first to third cutter units 25 to 27 is extended on the roller 61a positioned on the lower side so as to change the moving direction, and wound by the lower winding device 62. The band-like material 17 is extended on the roller 61b positioned on the upper side so as to change the moving direction, and wound by the upper winding device 63. That is, the movement of the band-like materials 16 and 17 in the direction (vertical direction) perpendicular to their surfaces is regulated as they come in contact with the rollers 61a and 61b.

As shown in FIG. 10, the lower roller 61a and upper roller 61b are arranged in positions where the angle which the band-like materials 16 and 17 make between the first to third cutter units 25 to 27 and the two rollers 61a and 61b is an angle α, when viewed in the axial direction of the first and second rotating shafts 23 and 24. The angle α is always constant without being affected by the winding amounts of the lower winding device 62 and upper winding device 63. The angle α is desirably 10°±3°.

Note that when the rollers 61a and 61b are not used, the angle which the band-like materials 16 and 17 make largely changes from the start of winding of the lower and upper winding devices 62 and 63 to the end of winding. This means that the directions in which the band-like materials 16 and 17 are pulled with respect to the medium 2 to be cut largely change from the start to the end of winding, so the quality of the cutting process largely changes.

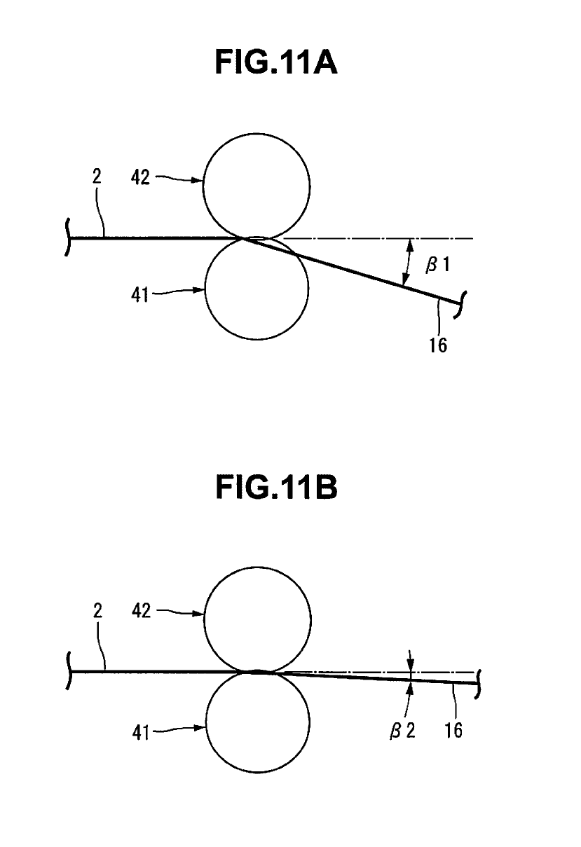

For example, the angle at which the band-like material 16 positioned on the lower side in FIG. 10 inclines to the almost horizontal orbit of the medium 2 to be cut, in other words, the contact angle between the medium 2 to be cut and the first and second rotary blades 41 and 42 is a relatively large angle β1 at the start of winding as shown in FIG. 11A, and a relative small angle β2 at the end of winding as shown in FIG. 11B. When the contact angle thus changes, the quality of the cutting process also changes.

The orbit guide 61 according to this embodiment regulates the orbits of the band-like materials 16 and 17 when they are wound by the lower and upper winding devices 62 and 63, in order to make the contact angles between the medium 2 to be cut and the first and second rotary blades 41 and 42 constant.

The lower and upper winding devices 62 and 63 include rewinders 62a and 63a which function as “winding rollers” on which the band-like materials 16 and 17 are wound, and a winding mechanism (not shown) for rotating the rewinders 62a and 63a.

The winding mechanism rotates the rewinders 62a and 63a in the winding direction by the motive power of a motor. Accordingly, the medium 2 to be cut is pulled by the upper and lower winding devices 62 and 63, moved in the cutting unit 20, and cut by the first to third cutter units 25 to 27.

The first and second rotary blades 41 and 42 used in the cutting apparatus 14 configured as described above are incorporated into one cutter unit (one of the first to third cutter units 25 to 27) in a state in which one surface of the first blade 41 and one surface of the second blade 42 are partially in contact with each other. When this cutter unit is moved along the first and second rotating shafts 23 and 24, the first and second rotary blades 41 and 42 move together in the axial direction of the first and second rotating shafts 23 and 24. The first and second rotary blades 41 and 42 rotate when the first and second rotating shafts 23 and 24 rotate.

Accordingly, when the position where the second cutter unit 26 cuts the medium 2 to be cut has changed because the widths of the first and second labels 6 and 7 of the medium 2 to be cut have changed, or when using the medium 2 to be cut having a different width, the cutting position can easily be changed by moving the first to third cutter units 25 to 27 in the axial direction.

Also, the cutting apparatus 14 cuts the medium 2 to be cut by the rotating first and second rotary blades 41 and 42, so the cut section is smooth, and the quality of the cutting process is high.

In this embodiment, therefore, the widths of the band-like materials 16 and 17 obtained by cutting the sheet-like medium 2 to be cut can easily be changed in accordance with the application. In addition, it is possible to provide a cutting apparatus capable of improving the quality of the cutting process by using the two rotary blades 41 and 42 which clamp the medium 2 to be cut.

The positions where the first and second rotary blades 41 and 42 used in the cutting apparatus 14 cut the medium 2 to be cut always change. Accordingly, this embodiment can provide a cutting apparatus capable of reducing the running cost by prolonging the life of the blade and decreasing the exchange frequency of the blade, when compared to a cutting apparatus using a non-rotary blade.

In this embodiment, the shape of the sections perpendicular to the axes of the first and second rotating shafts 23 and 24 and the shape of the holes 44 and 45 of the first and second rotary blades 41 and 42 are regular hexagons. In this embodiment, therefore, the function of transmitting the rotations of the first and second rotating shafts 23 and 24 to the first and second rotary blades 41 and 42 and the function of supporting the first and second rotary blades 41 and 42 so that they are movable in the axial direction can be implemented by simple arrangements.

Accordingly, this embodiment can reduce the manufacturing cost, and hence can provide a cutting apparatus in which two rotary blades are movable in the axial direction with a low cost.

The first to third cutter units 25 to 27 according to this embodiment include the branch guide 51 for guiding the pair of band-like materials 16 and 17 formed by cutting the medium 2 to be cut by the first and second rotary blades 41 and 42, in opposite directions at a predetermined angle in the vertical direction. Consequently, the two cut band-like materials 16 and 17 are smoothly fed to the downstream side without interfering with each other.

Also, the connecting member 48 forming a part of the branch guide 51 connects the lower housing 46 positioned on the reverse surface side of the medium 2 to be cut and the upper housing 47 positioned on the obverse surface side in the housing 43, without disturbing the movement of the two band-like materials 16 and 17.

Accordingly, the cutting apparatus 14 according to this embodiment can cut the medium 2 to be cut by the cutting unit 20 and smoothly feed the cut materials to the downstream side, although the first to third cutter units 25 to 27 and medium 2 to be cut cross each other.

The cutting apparatus 14 according to this embodiment includes the plurality of cutter units (the first to third cutter units 25 to 27). In this embodiment, therefore, the medium 2 to be cut can be cut in the plurality of positions in the widthwise direction, so a highly versatile cutting apparatus can be provided.

The cutting apparatus 14 according to this embodiment includes the orbit guide 61 for regulating the orbits of the band-like materials 16 and 17 obtained from the medium 2 to be cut which is cut by the first and second rotary blades 41 and 42, when winding the band-like materials 16 and 17 on the rewinders 62a and 63a, in order to make the contact angle between the medium 2 to be cut and the first and second rotary blades 41 and 42 constant.

When viewed in the axial direction of the first and second rotating shafts 23 and 24, therefore, the angle α which the band-like materials 16 and 17 make immediately after they are cut becomes constant.

Accordingly, this embodiment can provide a cutting apparatus by which the quality of the cutting process is high and uniform.

In addition, this embodiment can provide a compact cutting apparatus because the rolls of the wound band-like materials 16 and 17 can be arranged near the orbit guide 61.

The cutting apparatus 14 according to this embodiment includes the two slits 55 and 56 formed in the beam member of the frame 22, and the shaft portion (the shaft member 54) connected to the cutter unit and inserted into one of the slits 55 and 56. The two slits 55 and 56 extend in the axial direction of the first and second rotating shafts 23 and 24, and are aligned in the axial direction.

In this embodiment, therefore, the moving range of the cutter unit can be restricted in accordance with the application of the cutting process.

The cutting apparatus 14 according to this embodiment includes the first and second sensors 33 and 34 for sensing the presence/absence of the cutter units (the second and third cutter units 26 and 27) retracted to the two-end sides of the first and second rotating shafts 23 and 24. The cutting apparatus 14 also includes the controller 32 for stopping driving of the first and second rotating shafts 23 and 24 when the sensors 33 and 34 sense the cutter units retracted to the two-end sides of the first and second rotating shafts 23 and 24.

Accordingly, when the medium 2 to be cut is not to be cut (when the first to third cutter units 25 to 27 have moved to the retraction position), the first and second rotating shafts 23 and 24 automatically stop, so a readily operable cutting apparatus can be provided.

Note that in this embodiment, the example in which the shape of the first and second rotating shafts 23 and 24 and the shape of the holes 44 and 45 of the first and second rotary blades 41 and 42 are regular hexagons has been explained. However, these shapes can be any polygons as long as the first and second rotary blades 41 and 42 can be rotated together with the first and second rotating shafts 23 and 24, and it is also possible to adopt a square or triangle instead of a hexagon. In addition, each of the first and second rotating shafts 23 and 24 is not limited to a shaft having a polygonal sectional shape, and may also be a spline shaft. In this case, each of the holes 44 and 45 of the first and second rotary blades 41 and 42 is formed into a shape in which the spline shaft fits.

Furthermore, the upper passage 53 of the branch guide 51 according to this embodiment is formed into a shape by which a band-like material is fed along an almost horizontal orbit, and the lower passage 52 is formed into a shape by which a band-like material is fed along an upward orbit. However, the present invention is not limited to this. That is, the inclination angles of the lower passage 52 and upper passage 53 can appropriately be changed.

What is claimed is:

1. A label sheet cutting apparatus comprising:
a first rotating shaft and a second rotating shaft arranged parallel to each other;
a driving device configured to rotate the first rotating shaft and the second rotating shaft; and
a cutter unit including a first disc-like rotary blade and a second disc-like rotary blade each having a hole in a center, and a holding member configured to rotatably support the first rotary blade and the second rotary blade, and hold one surface of the first rotary blade and one surface of the second rotary blade such that the two surfaces are partially in contact with each other, the cutter unit configured to cut a sheet-like medium to be cut which is fed to pass between the first rotary blade and the second rotary blade,
wherein the first rotating shaft and the second rotating shaft are inserted into the holes of the first rotary blade and the second rotary blade and rotate the first rotary blade and the second rotary blade, respectively, and support the cutter unit such that the cutter unit is movable in an axial direction of the first rotating shaft and the second rotating shaft.

2. The apparatus according to claim 1, wherein the cutter unit includes a branch guide configured to guide a pair of band-like materials formed by cutting the medium to be cut by the first rotary blade and the second rotary blade, in opposite directions at a predetermined angle in a vertical direction.

3. The apparatus according to claim 1, wherein the cutter unit includes a plurality of cutter units.

4. The apparatus according to claim 1, further comprising: a winding roller configured to wind a pair of band-like materials formed by cutting by the first rotary blade and the second rotary blade and an orbit guide arranged downstream of the cutter unit and before the winding roller; wherein when winding the band-like materials by the winding roller, the orbit guide regulates orbits of the band-like materials in order to make a contact angle between the medium to be cut and the first rotary blade and the second rotary blade constant.

5. The apparatus according to claim 1, further comprising:
a frame including a beam member parallel to the first rotating shaft and the second rotating shaft;
two slits formed in the beam member, extending in an axial direction of the rotating shafts, and aligned in the axial direction; and
a shaft portion connected to the cutter unit and inserted into one of the slits.

6. The apparatus according to claim 5, further comprising:
sensors formed on the frame, and configured to sense presence/absence of the cutter units retracted to two-end sides of the first rotating shaft and the second rotating shaft; and
a controller configured to stop driving of the first rotating shaft and the second rotating shaft when the sensors sense the cutter units retracted to the two-end sides of the first rotating shaft and the second rotating shaft.

7. The apparatus according to claim 1, wherein a shape of sections perpendicular to axes of the first rotating shaft and the second rotating shaft and a shape of the holes of the first rotary blade and the second rotary blade are polygons.

8. The apparatus according to claim 1, wherein the medium to be cut is a label sheet including a release sheet, and a label including a sheet-like substrate and an adhesive layer formed on one surface of the substrate, and laminated to be releasable on the release sheet.
